(19) United States
(12) Patent Application Publication
(10) Pub. No.: US 2012/0155499 A1
(43) Pub. Date: Jun. 21, 2012

(54) MODE LOCKED FIBER LASER SYSTEM

(75) Inventors: Chien Ming HUANG, Chiayi City (TW); Shih Ting LIN, Tainan City (TW); Hsin Chia SU, Yuanchang Township (TW); Yao Wun JHANG, Chiayi City (TW)

(73) Assignee: INDUSTRIAL TECHNOLOGY RESEARCH INSTITUTE, Hsinchu (TW)

(21) Appl. No.: 13/022,859

(22) Filed: Feb. 8, 2011

(30) Foreign Application Priority Data
Dec. 16, 2010 (TW) 099144140

(51) Int. Cl. H01S 3/098

(52) U.S. Cl. 372/18

(57) ABSTRACT

A mode-locked laser system comprises a stimulating laser pump, a pulse-modulating laser pump, and an optical oscillator. The stimulating laser pump and the pulse-modulating laser pump emit a stimulating laser light and a pulse-modulating laser light. The optical oscillator further includes a gain medium, a saturable absorber, a first terminal, and a second terminal. The stimulating laser light and the pulse-modulating laser light are emitted into the gain medium to generate a gain laser light. When the gain laser light is emitted into the saturable absorber, an ultra-short pulse laser light is generated.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The disclosure relates to a mode locked laser system. Particularly, the disclosure relates to a mode locked fiber laser system having a passive mode-locked mechanism induced by dual laser pumps.

2. Description of Related Art Including Information Disclosed Under 37 CFR 1.97 and 37 CFR 1.98

Recently, since pulse laser systems are widely applied for optical communication, chemical reaction measurement, physical measurement, and distant measurement, studies focused on short pulse lasers have attracted more attention from industry and academia. The pico/femto second scale fiber lasers belonging to the short pulse laser have high potential in brittle material process, biomedical detection, and wavelength transform. Generally, the method of generating short pulse laser beam includes gain-switched or Q-switched mechanisms and the mode-locked mechanism. Compared with the gain-switched mechanism, the mode-locked mechanism can generate an ultra short pulse laser.

The mode-locked mechanism can be further divided into three types including the active mode-locked type, the passive mode-locked type, and the hybrid mode-locked type.

The frequency modulation of the radio frequency in the conventional mode-locked laser is the same as the pulse repetition rate thereof. When the pulse laser beam transmitted from a semiconductor laser amplifier during the peak of the frequency modulation is reflected, by a mirror, back to the semiconductor laser amplifier, the pulse laser beam overlaps with the peak of the frequency modulation such that the gain of the peak of the pulse laser beam is larger than that of the foot of the peak. After the resonance repeats several times, the energy can generate a short pulse laser.

The active mode-locked laser usually utilizes electro-optic modulators or acousto-optic modulators to implement the pulse selection mechanism after continuous wave transmitting. The pulse selection mechanism mainly utilizes a pulse picker to modulate polarization of the laser beam for selection. The wave-plate of the modulator requires over kilo-driving voltage to rapidly switch the polarization of the laser beam. Consequently, the polar splitter can select the required pulse frequency. This pulse selection mechanism can adjust its repetition rate, but it is unstable due to the environmental variation. In addition, the mechanism requires high driving voltage, manual adjustment of mechanical parts, and a high-cost modulator.

Moreover, the passive mode-locked type utilizes a saturable absorber with different transmittances to select the laser mode of the continuous wave. When the saturable absorber selects a laser mode, the saturated-absorption usually cracks due to small spot size. The benefit of the passive mode-locked type is low cost, but its repetition rate, determined by resonant cavity, cannot be adjusted.

### BRIEF SUMMARY OF THE INVENTION

According to an embodiment, a mode-locked laser system includes a stimulating laser pump, a pulse-modulating laser pump, and an optical oscillator. The stimulating laser pump and the pulse-modulating laser pump emit a stimulating laser beam and a pulse-modulating laser beam, respectively. The optical oscillator includes a gain medium, a saturable absorber, a first terminal, and a second terminal. The stimulating laser beam and the pulse-modulating laser beam are directed into the gain medium to generate a gain laser beam, which is guided into the saturable absorber to emit an ultra-short pulse laser beam. In addition, the ultra-short pulse laser beam is reflected between the first terminal and the second terminal.

The foregoing has outlined rather broadly the features and technical benefits of the disclosure in order that the detailed description of the invention that follows may be better understood. Additional features and benefits of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the disclosure. It should also be realized by those skilled in the art that such equivalent constructions do not depart from the spirit and scope of the invention as set forth in the appended claims.

### BRIEF DESCRIPTION OF THE SEVERAL VIEWS OF THE DRAWINGS

The accompanying drawings, which are incorporated in and constitute a part of this specification, illustrate embodiments of the disclosure and, together with the description, serve to explain the principles of the invention.

FIG. 1 shows a perspective view illustrating a mode-locked laser system according to one exemplary embodiment of the disclosure;

FIG. 2A shows a correlation diagram of laser intensity of the stimulating laser pump to time;

FIG. 2B shows a correlation diagram of laser intensity of the pulse-modulating laser pump to time; and

FIG. 3 show a perspective view illustrating a mode-locked laser system according to another exemplary embodiment of the disclosure.

### DETAILED DESCRIPTION OF THE INVENTION

The following description of the disclosure accompanies drawings, which are incorporated in and constitute a part of this specification, and illustrate embodiments of the disclosure, but are not limited to the embodiments. In addition, the following embodiments can be properly integrated to complete another embodiment.

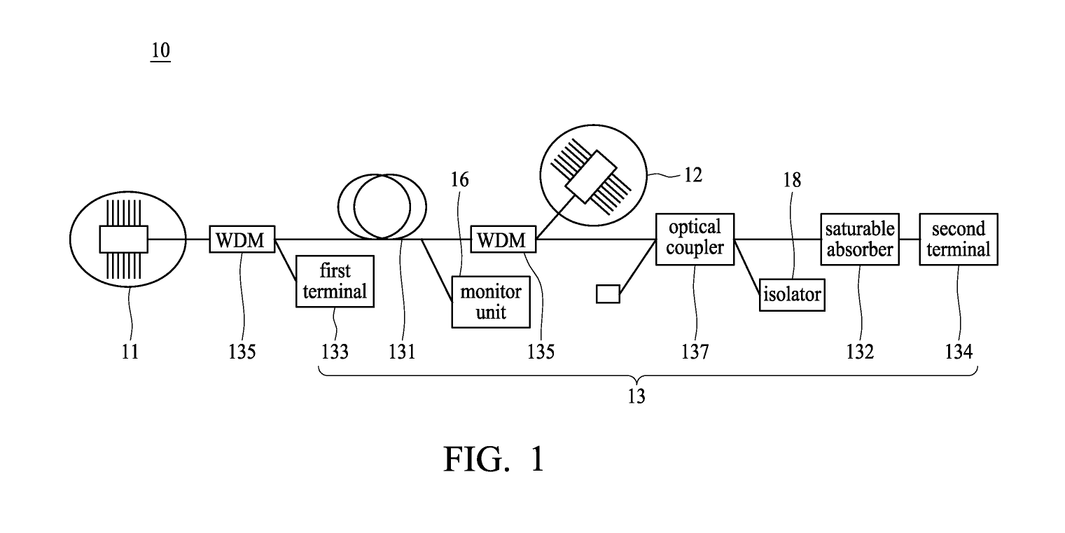

Referring to FIG. 1, according to one embodiment of the disclosure, a mode-locked laser system 10 includes a stimulating laser pump 11, a pulse-modulating laser pump 12, and an optical oscillator 13. The optical oscillator 13 is a total optical fiber system; however, in another embodiment (not shown), the optical oscillator 13 can include non-fiber devices. The optical oscillator 13 includes a gain medium 131, a saturable absorber 132, a first terminal 133, and a second terminal 134. In the embodiment, the mode-locked laser system 10 utilizes the stimulating laser pump 11 and the pulse-modulating laser pump 12 to stimulate the gain medium 131 together and to establish a total optical fiber laser system in a mode-locked mechanism. The total optical fiber system preferably includes, but is not limited to, a pico second scale laser system in total optical fiber.

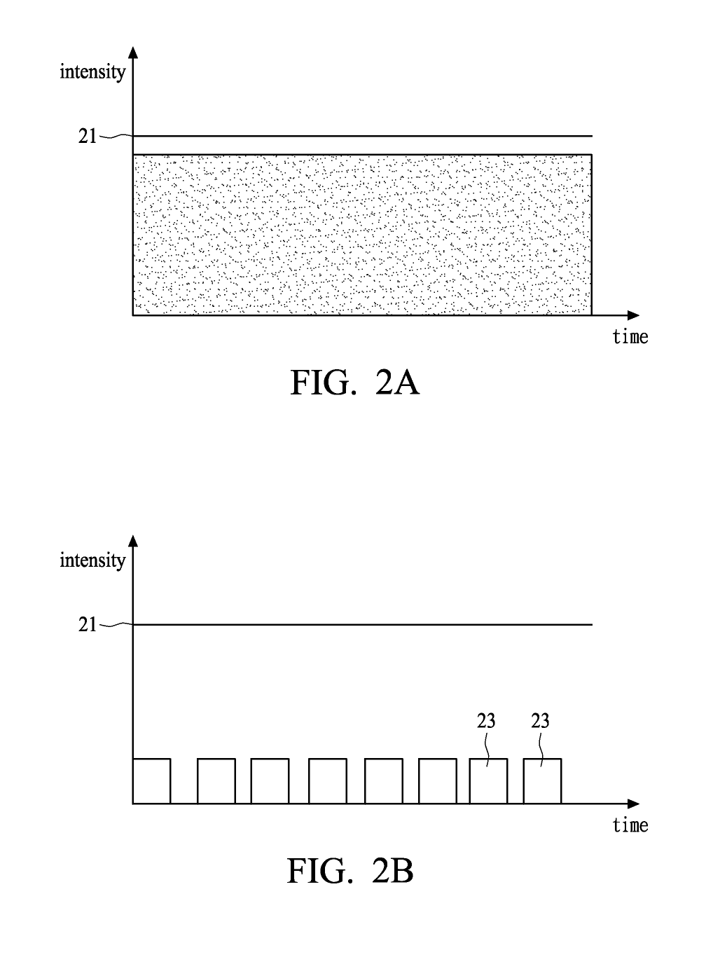

In the embodiment shown in FIG. 1, the optical oscillator 13 further includes at least one wavelength division multiplexor, WDM 135. The WDM 135 couples with the stimulating laser pump 11 for directing the stimulating laser beam from the stimulating laser pump 11 into the gain medium 131 of the optical oscillator 13 so as to stimulate the gain medium 131 to emit amplified spontaneous emission, ASE. In the embodiment, the stimulating laser pump 11 includes a continuous wave laser pump for generating wideband amplified spontaneous emission and controlling the threshold 21 (shown in FIG. 2A) for laser beam emission. In the embodiment shown in FIG. 1, another WDM 135 couples with the pulse-modulating laser pump 12 to direct the pulse-modulating laser beam from the pulse-modulating laser pump 12 to the gain medium 131 of the optical oscillator 13. In the embodiment shown in FIG. 1, the stimulating laser pump 11 and the pulse-modulating laser pump 12 are disposed on opposite sides of the gain medium 131. In other words, the stimulating laser beam and the pulse-modulating laser beam are respectively guided into opposite sides of the gain medium 131. However, in other embodiments (not shown), the stimulating laser pump 11 and the pulse-modulating laser pump 12 can be disposed on the same side of the gain medium 131. In other words, the stimulating laser beam and the pulse-modulating laser beam can be directed into the same side of the gain medium 131.

FIG. 2A illustrates a correlation diagram of laser intensity of the stimulating laser pump to time, wherein the y-axis shows the intensity of the stimulating laser pump, while the x-axis shows time. FIG. 2B shows a correlation diagram of laser intensity of the pulse-modulating laser pump to time, wherein the y-axis shows the intensity of the pulse-modulating laser pump, while the x-axis shows time. FIG. 2A shows that when the stimulating laser beam emitted form the stimulating laser pump 11 is directed into the gain medium 131, the energy is still not over the threshold 21 of outputting the gain laser beam.

The population inversion formula 1 calculated by rate equation shows the following:

$$\frac{\partial {n}_{2}}{\partial t} = - {A}_{21} {n}_{2} + \frac{{σ}_{13} {l}_{p}}{{hv}_{p}} {n}_{1} + \frac{{σ}_{12} {l}_{s}}{{hv}_{s}} {n}_{1} - \frac{{σ}_{21} {l}_{s}}{{hv}_{s}} {n}_{2}$$

$$\frac{\partial {n}_{1}}{\partial l} = + {A}_{21} {n}_{2} - \frac{{σ}_{13} {l}_{p}}{{hv}_{p}} {n}_{1} - \frac{{σ}_{12} {l}_{s}}{{hv}_{s}} {n}_{1} + \frac{{σ}_{21} {l}_{s}}{{hv}_{s}} {n}_{2}$$

n₁ means the photon population in n₁ energy state. n₂ means the photon population in n₂ energy state. Generally, when the photon population in n₂ energy state in a time unit is well above zero, the laser pump has a large power so as to emit a laser beam, a coherent light beam. The disclosure utilizes the stimulating laser pump 11 to emit the continuous wave so as to generate amplified spontaneous emission. FIG. 2A shows that we can control the threshold 21 for emitting laser beams. In other words, we can control the photon population in n2 energy state so that it is not too far above zero. As FIG. 1 and FIG. 2B show, the disclosure utilizes the pulse-modulating laser pump 12 to generate the pulse-modulating laser beam. After the pulse-modulating laser beam is directed into the gain medium 131 of the optical oscillator 13, a gain laser beam is generated by modulating the gain medium 131. The pulse-modulating laser beam emitted from the pulse-modulating laser pump 12 includes a plurality of pulses 23. After the pulse-modulating laser beam is directed into the gain medium 131, many photons remaining in the metastable state receive the energy of the pulse-modulating laser to rapidly decline so as to emit the gain laser beam. In other words, the stimulating laser beam enables electrons of the gain medium 131 to access the threshold 21 for emitting the gain laser beam, while the pulse-modulating laser beam induces the gain medium 131 in fluctuation to generate the gain laser beam. The wideband wavelength of the gain laser beam ranges from 1020 to 1060 nanometers.

In the embodiment shown in FIG. 1, the WDM 135 couples with the first terminal 133. Since the most-common coupling method of the optical fibers is to fuse splice, the mode-locked laser system 10 includes many fuse splice points. In addition, the gain medium 131 is a gain fiber, whose core ranges from about 3 to 30 micrometers. The gain fiber of the embodiment is doped ytterbium, but the gain fiber can be doped with an element selected from the group consisting of erbium, praseodymium, thulium, and holmium. In the embodiment, the saturable absorber 132 of the optical oscillator 13 is a high gain optical fiber for mode-locking the ultra-short pulse laser beam. The gain laser beam is directed into the saturable absorber 132 to emit an ultra-short pulse laser beam. Particularly, the life cycle of the amplified spontaneous emission in the ytterbium-doped gain fiber is about 850 microseconds. In the initial 200 microseconds, the amplified spontaneous emission includes multiple modes, which are stimulated by the pulse-modulating laser beam to generate the gain laser beam being passive mode-locked through the saturable absorber 132 of optical fiber. Although the disclosure belongs to a passive mode-locked laser system, the passive mode-locked laser can actively control the pulse adjustment of the pulse-modulating laser. In this embodiment, the ultra-short pulse laser beam is reflected between the first terminal 133 and the second terminal 134. Since the optical oscillator 13 is formed by splice-fusing, the gain medium 131 and the saturable absorber 132 both are optical fiber structure. The optical oscillator 13 can be integrated as a single structure for reducing volume, reducing the size of the whole laser system, and the optical oscillator 13 can be protected from outside disturbance such as vibration to increase the stability of the mode-locked system.

In the embodiment shown in FIG. 1, the monitor unit 16 coupled with the WDM 135 is capable of monitoring the energy of the gain laser beam or the ultra-short pulse laser beam so as to adjust the parameters of the mode-locked laser system 10. In the embodiment, the optical oscillator 13 further includes an optical coupler 137, coupled with the saturable absorber 132 for outputting the ultra-short pulse laser. The mode-locked laser system 10 of the disclosure further includes a polarization dependent isolator 18, coupled with the optical coupler 137 for one-way outputting the ultra-short laser beam. In addition, in another embodiment (not shown), the first terminal 133 and the second terminal 134 of the optical oscillator 13 can be coated reflection mirrors, wherein the coating film of the coated reflection mirror can be designed according to its reflective index. Thus, one part of the ultra-short pulse laser beam can pass through the coated reflection mirror, while the other part of the ultra-short pulse laser beam cannot. Furthermore, the first terminal 133 and the second terminal 134 can be respectively designed to be selected from the group consisting of a reflection mirror, a fiber bragg grating, and a semiconductor saturable absorber mirror.

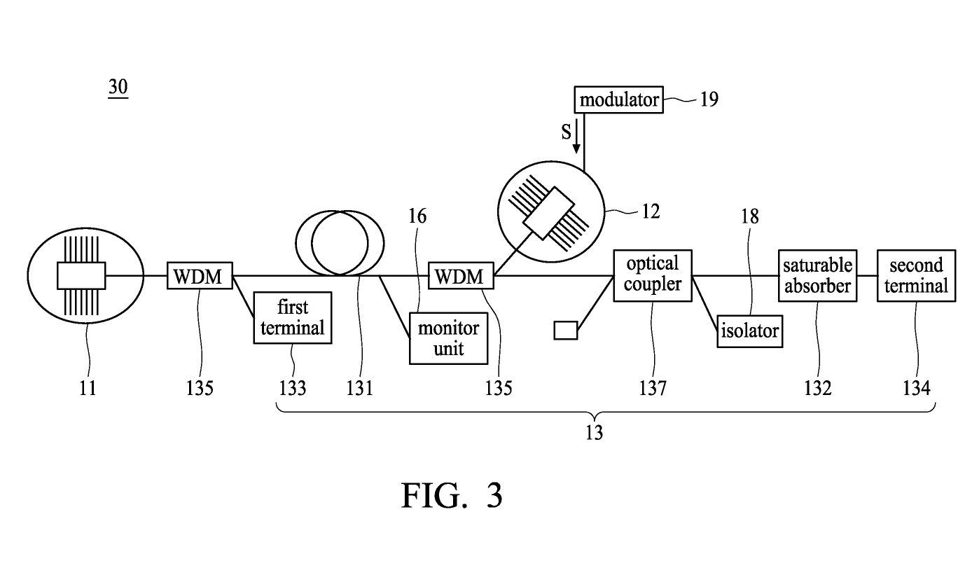

In another embodiment shown in FIG. 3, the mode-locked laser system 30 includes a stimulating laser pump 11, a pulse modulating laser pump 12, a modulator 19, and an optical oscillator 13. The optical oscillator 13 is a total optical fiber structure. The optical oscillator 13 includes a gain medium 131, a saturable absorber 132, a first terminal 133, and a second terminal 134. The modulator 19 coupled with the pulse-modulating laser pump 12 transmits an electrical signal S to the pulse-modulating laser pump 12. The electrical signal S includes a direct current signal and a pulse signal, and the electrical signal S drives the pulse-modulating laser pump 12 to emit a pulse-modulating laser beam. The modulation of the pulse-modulating laser beam can range between one shot per second and one million shots per second. When the pulse-modulating laser pump receives the pulse signal to generate a coherent laser pulse signal, the time interval of the pulse signal is greater than the time interval of the coherent laser pulse signal. Additionally, a wavelength range of the pulse-modulating laser beam is selected from the group consisting of 790 to 820 nanometers, 900 to 930 nanometers, and 960 to 990 nanometers.

Although the disclosure and its benefits have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the disclosure is not intended to be limited to the particular embodiments of the apparatus, system, machine, device, composition of matter, means, structure and steps described in the specification. As one of ordinary skill in the art will readily appreciate from the disclosure, apparatuses, system, machines, devices, compositions of matter, means, structures, or steps, presently existing or later to be developed, that perform substantially the same function or achieve substantially the same result as the corresponding embodiments described herein may be utilized according to the disclosure. Accordingly, the appended claims are intended to include within their scope such apparatuses, system, machines, device, compositions of matter, means, structures, or steps.

We claim:

1. A mode-locked laser system, comprising:
a stimulating laser pump, emitting a stimulating laser beam;
a pulse-modulating laser pump, emitting a pulse modulating laser beam; and a optical oscillator, including:
a gain medium, into which the stimulating laser beam and the pulse modulating laser beam are directed to emit a gain laser beam;
a saturable absorber, into which the gain laser beam is directed to emit an ultra-short pulse laser beam; and
a first terminal and a second terminal, wherein the ultra-short pulse laser beam is reflected between the first terminal and the second terminal.

2. The mode-locked laser system of claim 1, wherein the optical oscillator further includes at least one wavelength-division multiplexor, the wavelength-division multiplexor couples with the stimulating laser pump or the pulse modulating laser pump.

3. The mode-locked laser system of claim 2, wherein the wavelength-division multiplexor couples with the first terminal.

4. The mode-locked laser system of claim 2, wherein the wavelength-division multiplexor couples with a monitor unit and the monitor unit detects energy of the gain laser beam or the ultra-short pulse laser beam.

5. The mode-locked laser system of claim 1, wherein the optical oscillator further includes an optical coupler, the optical coupler couples with the saturable absorber.

6. The mode-locked laser system of claim 5, further comprising a polarization dependent isolator, wherein the polarization dependent isolator couples with the optical coupler for one-way outputting of the ultra-short pulse laser beam.

7. The mode-locked laser system of claim 1, wherein modulation of the pulse-modulating laser beam ranges between one shot per second and one million shots per second.

8. The mode-locked laser system of claim 1, further comprising a modulator, coupling with the pulse-modulating laser pump and transmitting an electrical signal to the pulse-modulating laser pump, wherein the electrical signal includes a direct current signal and a pulse signal, and the electrical signal drives the pulse-modulating laser pump to emit the pulse-modulating laser beam.

9. The mode-locked laser system of claim 8, wherein the stimulating laser beam stimulates electrons of the gain medium to access a threshold of emitting the gain medium laser beam, and the pulse-modulating laser beam generates the gain laser beam in fluctuation.

10. The mode-locked laser system of claim 8, wherein the pulse-modulating laser pump receives the pulse signal to generate a coherent laser pulse signal, and the time interval of the pulse signal is greater than the time interval of the coherent laser pulse signal.

11. The mode-locked laser system of claim 1, wherein a wavelength range of the pulse-modulating laser beam is selected from the group consisting of 790 to 820 nanometers, 900 to 930 nanometers, and 960 to 990 nanometers.

12. The mode-locked laser system of claim 1, wherein the gain medium includes a gain fiber, and a core of the gain fiber ranges from 3 to 30 micrometers.

13. The mode-locked laser system of claim 2, wherein the gain medium includes a gain fiber, and a core of the gain fiber ranges from 3 to 30 micrometers.

14. The mode-locked laser system of claim 9, wherein the gain medium includes a gain fiber, and a core of the gain fiber ranges from 3 to 30 micrometers.

15. The mode-locked laser system of claim 12, wherein the gain fiber is doped with an element selected from the group consisting of ytterbium, erbium, praseodymium, thulium, and holmium.

16. The mode-locked laser system of claim 1, wherein the saturable absorber includes a high gain optical fiber for mode-locking the ultra-short pulse laser beam.

17. The mode-locked laser system of claim 5, wherein the saturable absorber includes a high gain optical fiber for mode-locking the ultra-short pulse laser beam.

18. The mode-locked laser system of claim 1, wherein the first terminal is selected from the group consisting of a reflection mirror, a coated reflection mirror, a fiber bragg grating, and a semiconductor saturable absorber mirror.

19. The mode-locked laser system of claim 1, wherein the second terminal is selected from the group consisting of a reflection mirror, a coated mirror, a fiber bragg grating, and a semiconductor saturable absorber mirror.

20. The mode-locked laser system of claim 1, wherein the stimulating laser pump is a continuous wave laser pump for generating wideband amplified spontaneous emission.
